(19) United States
(12) Patent Application Publication
(10) Pub. No.: US 2004/0105068 A1
(43) Pub. Date: Jun. 3, 2004

(54) Spectacles with cushioning assembly

(76) Inventor: Klaus Wiedner, Furth (DE)

Correspondence Address: BROWDY AND NEIMARK, P.L.L.C., 624 NINTH STREET, NW, SUITE 300, WASHINGTON, DC, 20001-5303, US

(21) Appl. No.: 10/470,919

(22) PCT Filed: Jan. 17, 2002
(86) PCT No.: PCT/EP02/00426

(30) Foreign Application Priority Data
Feb. 1, 2001 (DE) 201 01 723.7

(51) Int. Cl. G02C 1/04

(52) U.S. Cl. 351/106

(57) ABSTRACT

In a pair of glasses comprising a sight piece (3) with a bridge piece (6) and side members (4) which are hinged to the sight piece (3) or to a frame (2) that is allocated to the sight piece (3), with cushioning arrangements (28) being provided in zones (9, 22) of contact with a user's face for increased convenience of wearing, it is provided that the ends (27) of the side members (4) and/or the inside of a top (16) of the frame (2) and/or parts of the bridge piece (6) are cushioned approximately in the shape of a Z.

The invention relates to a pair of glasses comprising a sight piece with a bridge piece and side members which are hinged to the sight piece or to a frame that is allocated to the sight piece, cushioning arrangements being provided in the zones of contact with a user's face for increased convenience of wearing.

Familiar frames of hard plastic material or metal are rather rigid, as a result of which pressure sores are possible on the bridge of the nose or behind the ears. These sores occur above all upon permanent and abrupt motions of the head, which considerably reduces the convenience of wearing of the glasses.

These drawbacks can be overcome by using cushions of softer plastic material. Pads of softer plastic material with the inclusion of liquid or air are known to be used. Injection-molded cushions of plastic material with comparatively thin-walled bulgings have been used for increased convenience of wearing. A cushioning arrangement of this type has for example been described in EP 0 529 202 A1 in connection with industrial safety goggles. Injection-molding the pad of plastic material requires a separate step in production, causing additional manufacturing costs.

It is an object of the invention to embody a pair of glasses with cushioning arrangements in such a way that the cushioning elements of the side member and the cushioning elements of the frame can be manufactured in a single step of production.

According to the invention, this object is attained in that the tail piece of the side members and/or the inside of a top of the frame and/or parts of the nose contact zone are cushioned in the shape of a Z.

This arrangement provides for excellent cushioning and considerably reduces manufacturing requirements as compared to conventional familiar glasses.

In keeping with another favorable embodiment of the invention, it is provided that the areas in the shape of a Z are integral with the end of a side member and/or the top of the frame and/or the nose contact zone.

This design requires only few steps in manufacture, as a result of which manufacturing cost is kept low. Detaching the cushioning arrangements from the frame or side members is precluded.

By advantage, the Z-shaped areas are punched, in particular along the respective contact zone.

As a result, the zone of a wearer's contact with the cushioning arrangements can be reduced to a minimum. The recesses enable glasses of inferior weight and extraordinary design to be created.

Appropriately, the ends of the side members can be joined to each other by clipping. By alternative, an additional plastic member or strip may be provided for connection.

In this case, there is no need for any additional string when the glasses are taken off and worn around the neck.

Details of the invention will become apparent from the ensuing description of a preferred embodiment, taken in conjunction with the drawing, in which:

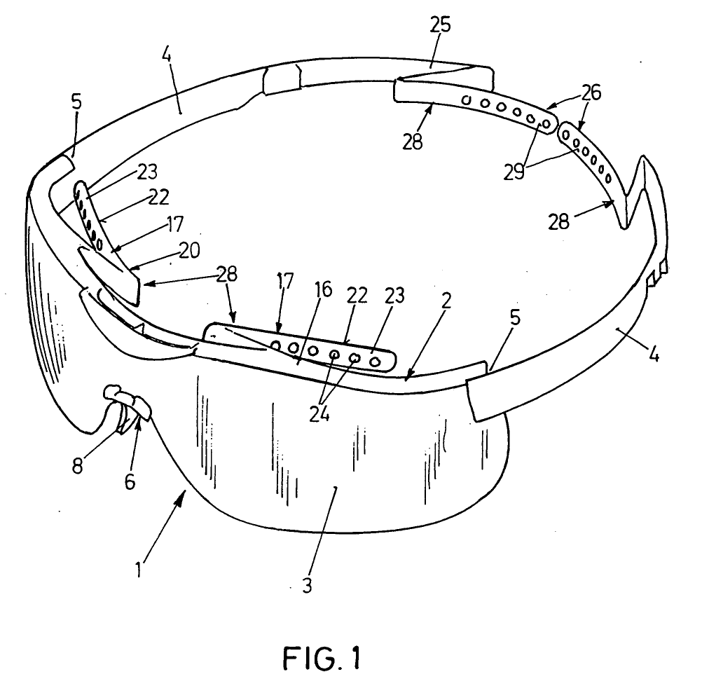

FIG. 1 is a perspective view of a pair of glasses according to the invention;

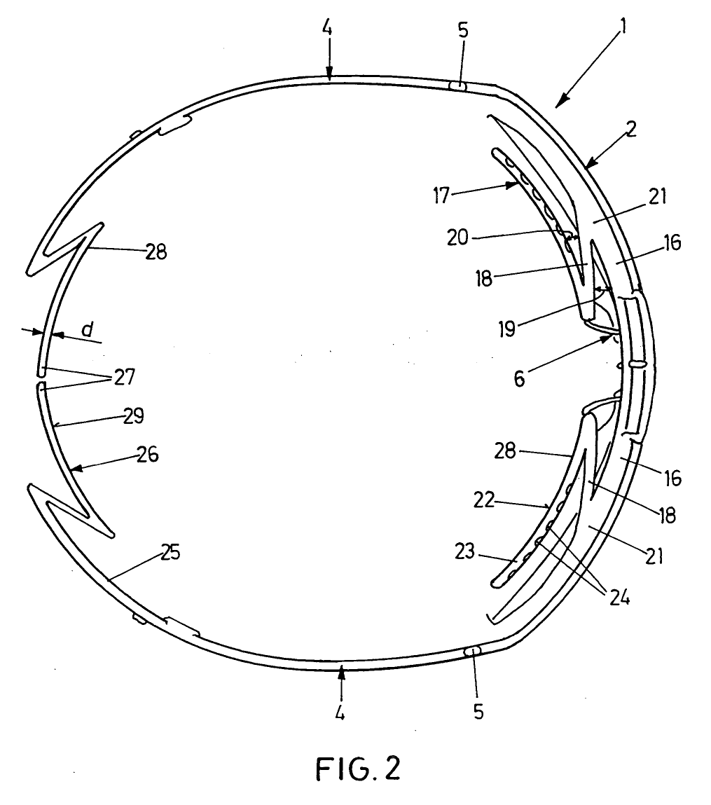

FIG. 2 is a plan view of a pair of glasses according to the invention; and

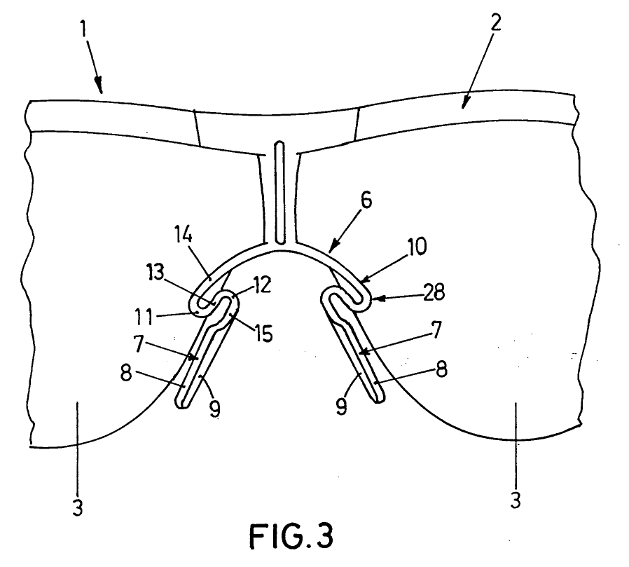

FIG. 3 is a partial elevation of a pair of glasses according to the invention.

A pair of glasses denoted by 1 includes a frame 2 and a sight piece 3, with side members 4 being hinged to the sides the frame 2 and the sight piece 3 by hinge pins 5. As a result of the hinge pins 5, the side members 4 are foldable without any problems and space-saving.

The frame 2 and the sight piece 3 are curved for optimal adaptation to a wearer's head. The side members 4 taper off the curvature of the frame 2.

The frame 2 further comprises a symmetrical bridge piece 6 which is integral with the frame 2. The two sides 7 that taper off the bridge piece 6 are each provided with a nose piece 8 which constitutes the nose contact zone 9. The nose pieces 8 are joined to the bridge piece 6 in the shape of a Z or S along an area 10, with the bridge piece 6 and the nose pieces 8 being integral.

Between two bends 11, 12, the Z- or S-shaped area 10 comprises an intermediate piece 13 which runs almost parallel to, and at a certain distance from, the lead-in piece 14 and the lead-out piece 15 of the Z-shaped or S-shaped area 10, with the lead-out piece 15 projecting towards the zone provided for the nose. The intermediate piece 13 slightly reverses along the lead-in piece 14 at a distance therefrom.

For increased convenience of wearing, the nose contact zone 9 may be punched.

The top 16 of the frame 2 comprises another Z-shaped area 17 which includes an intermediate piece 18 between a lead-in piece 21 and a lead-out piece 23. The two angles 19, 20 of the Z are acute angles, preferably of approximately 20°. In this Z-shaped area 17, the top 16 of the frame constitutes the lead-in piece 21. The intermediate piece 18 runs by the angle 19 along the top 16, whereas the lead-out piece 23 projects into the glasses 1, forming the zone of contact 22. The Z-shaped area 17 and the frame 2 are formed in one piece.

The intermediate pieces 13 and 18 are shorter than the respective nose contact zone 9 and contact zone 22.

For increased convenience of wearing, the contact zone 22 is provided with holes 24. Other shapes of recesses are conceivable too, such as squares, rectangles or ellipses.

The tail piece 25 of the side member 4 includes a Z-shaped area 26 with a contact zone 29, which is identical with the design and function of the Z-shaped areas 10 and 17 described above.

The side member 4 may be provided with recesses in the vicinity of the hinge pin 5. The side members 4 have a constant thickness d over the entire length. The ends 27 of the side members can be joined to each other by clipping, in which case the glasses 1, when taken off, can be worn around a wearer's neck.

As a result of the low number of components, these cushioned glasses 1 can be manufactured rapidly and easily and therefore at a low cost.

The glasses 1 may be made from titanium or aluminum, with Z-shaped areas 10, 17, 26 of plastic material being fastened to such a metal frame.

Since the glasses 1 are provided in particular for industrial safety use, the cushioning arrangements 28 obtain additional safety by offering a “crumple zone”.

A design as industrial safety glasses may include a roof-type cover extending from the frame 2 towards a user's face in particular in the vicinity of the nose.

Upon use as sports and skiing glasses or sunglasses, it is conceivable to coat, or injection-mold around, the Z-shaped areas 10, 17, 26 for a soft configuration to be obtained that is externally closed.

In conclusion, the Z-shaped cushioning areas 10, 17, 26 according to the invention enable the glasses to optimally adapt to any size and shape of head and in particular also to any shape of nose.

1. A pair of glasses comprising a sight piece (3) with a bridge piece (6) and side members (4) which are hinged to the sight piece (3) or to a frame (2) that is allocated to the sight piece (3), with cushioning arrangements (28) being provided in the zones of contact (9, 22) with a user's face for increased convenience of wearing, characterized in that the tail piece (25) of the side members (4) and/or the inside of a top (16) of the frame (2) and/or parts of the bridge piece (6) are cushioned approximately in the shape of a Z.

2. A pair of glasses according to claim 1, characterized in that the areas (10, 17, 26) in the shape of a Z are integral with the ends (27) of the side members (4) and/or the top (16) of the frame (2) and/or the bridge piece (6).

3. A pair of glasses according to claim 1, characterized in that the Z-shaped areas (10, 17, 26) are punched in particular along the respective contact zones (9, 22, 29).

4. A pair of glasses according to claim 1, characterized in that the ends (27) of the side members (4) are fixable to each other by clipping directly or via an inserted plastic member of plastic strip.
